(19) United States
(12) Patent Application Publication
(10) Pub. No.: US 2008/0158698 A1
(43) Pub. Date: Jul. 3, 2008

(54) LENS BARREL ARRAY AND LENS ARRAY AND THE METHOD OF MAKING THE SAME

(76) Inventors: Chao-Chi CHANG, Taipei City (TW); Yung-I Chen, Taipei City (TW); Raymond Chin-Chung Hsiao, Taipei City (TW)

Correspondence Address: SINORICA, LLC, 528 FALLSGROVE DRIVE, ROCKVILLE, MD, 20850, US

(21) Appl. No.: 11/769,805

(22) Filed: Jun. 28, 2007

(30) Foreign Application Priority Data
Dec. 29, 2006 (TW) 95223188
May 8, 2007 (TW) 96116333

(51) Int. Cl. G02B 7/02; B29D 11/00

(52) U.S. Cl. 359/819; 264/1.1; 264/1.36; 264/1.37

(57) ABSTRACT

The present invention provides a lens barrel array, a lens array and a method of making the same. The lens barrel array is realized all together in collective operation, and intended to be separated later on to be used as lens barrels of individual module. The lens array including plates, each of which has a hollow portion, attached together and lenses mounted in the hollow portions respectively. The lens array is intended to be separated later on to be used as lens barrels of individual module. The method includes the steps of providing a plurality of plates with hollow portions thereon, installing lenses into the hollow portions respectively, and attaching the plates together to form lens barrel array with a plurality of lens, each of which includes the hollow portion and the lenses, intended to be separated later on to be used as lens barrels of individual module.

### BACKGROUND OF THE INVENTION

1. Field of the Invention

The present invention relates generally to an optical lens, and more particularly to a lens barrel array, lens array and the method of making the same.

2. Description of the Related Art

Typically, a conventional optical lens includes a base, a barrel and a lens. The base and the barrel usually are made of plastic and made by injection molding for mass production. As the image sensors are made smaller, the lenses have to be made smaller to match the image sensor. The injection molding cannot make the base and the barrel with precise sizes as requirement. Except that, the plastic part of the optical lens has a restriction in heat-resistant property because that the optical lens has to be processed for package. As a result, it is necessary to provide the plastic part with a high precise size and a high heat-resistant property to be incorporated in high precise optical lens and for automatic process.

In addition, conventional barrels are made of plastic and made by injection molding and the inside scale is hard to measure that we cannot make sure of the exact location of the lens. When there are two or more lenses mounted in the conventional barrel, it is harder to find out whether the lenses are eccentric, inclined, or bad locating. The die of injection molding usually has a lot of rounds that makes the barrel having rounds. Theses rounds generate interference in assembly of the lenses and make the lenses deviate their desired positions.

### SUMMARY OF THE INVENTION

The primary objective of the present invention is to provide a lens barrel array, a lens array and the method of making the same, which produces a plurality of lens barrels and lenses with high precision and thermal stability for high precise optical lenses.

According to the objective of the present invention, an array of lens barrels is realized all together in collective operation, and intended to be separated later on to be used as lens barrels of individual module.

The present invention further provides a lens array including plates, each of which has a hollow portion, attached together and lenses mounted in the hollow portions respectively. The lens array is intended to be separated later on to be used as lens barrels of individual module.

The present invention further provides a method of making the lens array, which includes providing a plurality of plates with hollow portions thereon, installing lenses into the hollow portions respectively, and attaching the plates together to form lens barrel array with a plurality of lens, each of which includes the hollow portion and the lenses, intended to be separated later on to be used as lens barrels of individual module.

### BRIEF DESCRIPTION OF THE DRAWINGS

FIG. 1 is a perspective view of a first preferred embodiment of the present invention;

FIG. 2 is a lateral view of FIG. 1;

FIG. 3 is a lateral view of a second preferred embodiment of the present invention;

FIG. 4 is a perspective view of a third preferred embodiment of the present invention;

FIG. 5 is a perspective view of a fourth preferred embodiment of the present invention;

FIG. 6 is an exploded view of the fourth preferred embodiment of the present invention; and

FIG. 7 is a flow chart of a method of making the fourth preferred embodiment of the present invention.

### DETAILED DESCRIPTION OF THE INVENTION

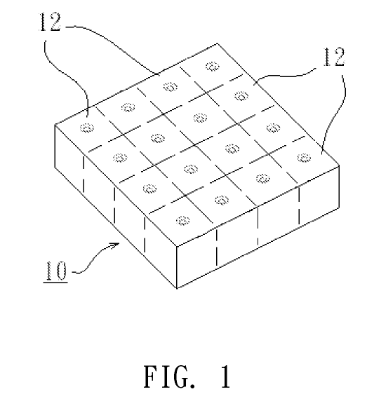

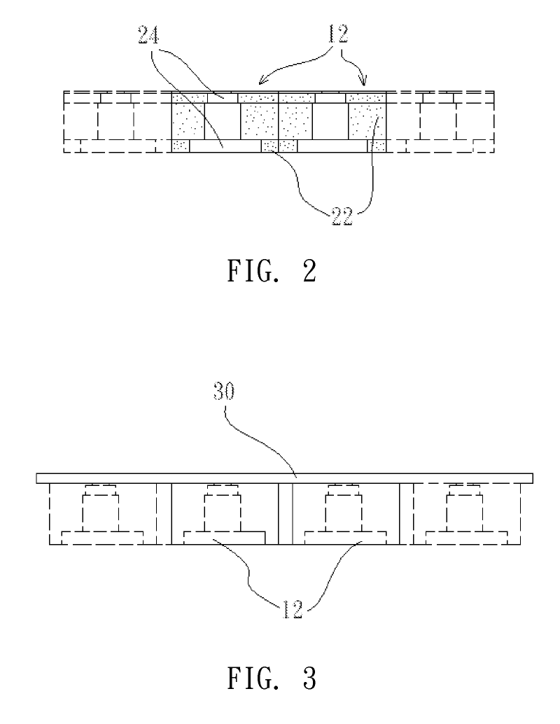

FIG. 1 and FIG. 2 show a lens barrel array 10 of a preferred embodiment of the present invention, which includes a plurality of lens barrels 12 all together in collective operation. The lens barrel array 10 is made by following steps.

Performing wet etching or dry etching on a plurality of plates 22, which are made of silicon wafer, to form a plurality of hollow portions 24 thereon. And then, the plates are attached together to form the lens barrel array 10. The hollow portions 24 form chambers of the lens barrels 12.

In addition, it may perform lithography electroforming micro molding (LIGA) on a plate 30, which is made of glass or metal, to make a plurality of multi-order barrels 12, referring to FIG. 3, to form the lens barrel array 10 also.

A third method of making the lens barrel array 10 is project laser on a plurality of glasses or ceramic plates 22 to form the hollow portions 24, and then attaching the plates 22 processed by laser together to form the lens barrel array 10 with the lens barrels 12.

The lens barrel array 10 of the present invention is incorporated in a process of assembling optical lenses to increase the efficiency of assembly of optical lenses. The lens barrel array 10 may be separated later on to be used as lens barrels 12 of individual module. The lens barrels 12 will be assembled with a lens base, one or more lenses and other essential elements (not shown) to complete a plurality of optical lenses. The lens barrels 12 may be assembled with lens base, lenses and other essential elements (not shown) respectively before separation. After separation of the lens barrels 12, it will get a plurality of optical lenses directly. The process increases the efficiency of assembly of optical lenses.

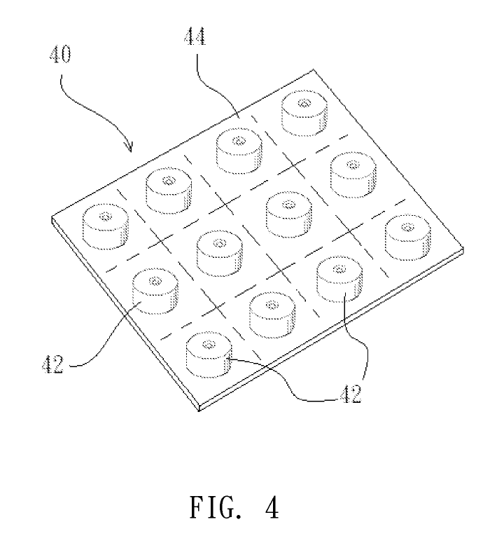

FIG. 4 shows a lens barrel array 40 of the third preferred embodiment of the present invention, which is similar to the lens barrel array 10 of the preferred embodiment, except that lens barrels 42 of the lens barrel array 40 are connected by a connecting plate 44.

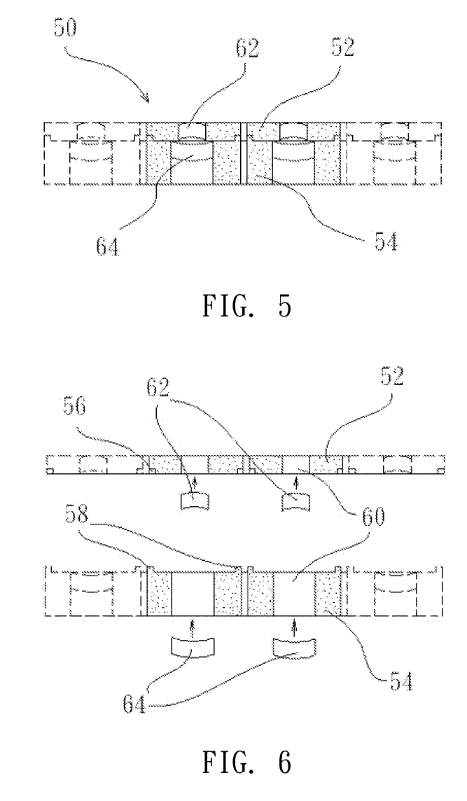

FIG. 5 and FIG. 6 show a lens array 50 of the fourth preferred embodiment of the present invention, which is similar to the lens barrel array 10 of the preferred embodiment, except that plates 52 and 54 are provided with slots 56 and protrusions 58 for mechanical alignment. Lenses 62 and 64 are fixed in hollow portions 60 respectively by glue or rings to form the lens array 50.

The hollow portions 60 are aligned with image sensors (not shown) so that the lens array 50 may be combined with a plurality of image capture modules to be separated into a plurality of lens modules. The process of the present invention increases the efficiency of assembly of optical lenses.

A method of making the lens array 50 includes the following steps:

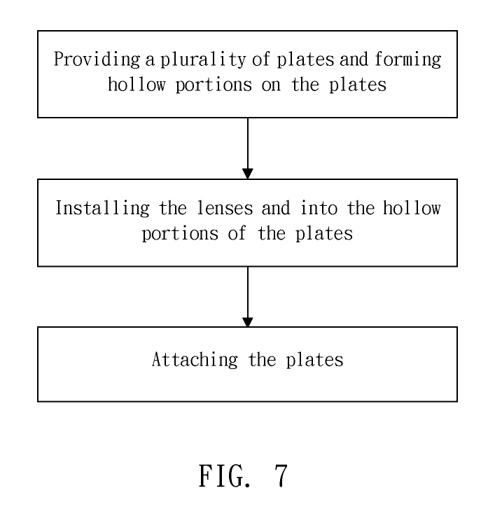

As shown in FIG. 7, the first step is providing a plurality of plates and forming hollow portions 60 on the plates 52 and 54 respectively. The plates 52 and 54 may be made of silicon wafer, metal, glass, ceramics or heat-resisting plastic.

The second step is installing the lenses 62 and 64 into the hollow portions 60 of the plates 52 and 54 respectively. The lenses 62 and 64 are fixed and tested.

The third step is attaching the plates 52 and 54 together with the engagement of the slots 56 and the protrusions 58 as described above to complete the lens array 50.

In conclusion, the lens barrel array, the lens array and the method of making the same of the present invention may produce a plurality of optical lenses in a single process that has a high efficiency of product. The lens array is made of heat-resisting material that the present invention may be incorporated in semiconductor process, such as SMT process. In combination of the lenses and the image capture modules, the present invention will not affect the optical properties that meet the requirement for high precise optical lenses. The plates may be used as the holders of optical films laminated on the lenses that give a protection against contamination.

The description above is a few preferred embodiments of the present invention and the equivalence of the present invention is still in the scope of the claim of the present invention.

What is claimed is:

1. An array of lens barrels, comprising a plurality of lens barrels tiled together.

2. The lens barrel array as defined in claim 1, wherein the lens barrels intended to be separated later on to be used as individual module.

3. The lens barrel array as defined in claim 1, wherein each of the lens barrels includes plates connected to each other, and each of the plates has hollow portions to form a chamber in the lens barrel.

4. The lens barrel array as defined in claim 1, further covered by a substrate, intended to give a protection against contamination and or against infrared radiation.

5. A combination of two or more lens array as defined in claim 1, with the means to mechanically align these arrays in order to precisely define the optical axis of the optical stack formed by the superposition of the lens barrel arrays.

6. A lens barrel array as defined in claim 5, wherein the mechanical alignment is defined by protrusions or slots in the array.

7. The lens barrel array as defined in claim 5, wherein each of the plates is made of silicon.

8. The lens barrel array as defined in claim 5, wherein each of the plates is made of a heat-resisting material.

9. The lens barrel array as defined in claim 8, wherein the heat-resisting material is selected from the group consisting of metal, glass, ceramics, and heat-resisting plastic.

10. A method of making the lens array as defined in claim 5, comprising the steps of:
providing a plurality of plates and providing hollow portions on each of the plates;
providing lenses in the hollow portions of the plates; and
attaching the plates together to have the hollow portions and the lenses forming a plurality of lens modules for division.

11. The method as defined in claim 10, wherein the hollow portions of the plates are made by dry etching or wet etching.

12. The method as defined in claim 10, wherein the hollow portions of the plates are made by lithography electroforming micro molding (LIGA).

13. The method as defined in claim 10, wherein the hollow portions of the plates are made by sol-gel process or sintering process.

14. The method as defined in claim 10, wherein the hollow portions of the plates are formed by laser.
